(19) United States
(12) Patent Application Publication
(10) Pub. No.: US 2014/0187713 A1
(43) Pub. Date: Jul. 3, 2014

(54) VIRBRATION-DAMPING MATERIAL AND PRODUCTION METHOD THEREFOR

(71) Applicant: TOKAI RUBBER INDUSTRIES, LTD., Komaki-shi (JP)

(72) Inventors: Naoki Oyaizu, Komaki-shi (JP); Kazutaka Katayama, Komaki-shi (JP)

(73) Assignee: TOKAI RUBBER INDUSTRIES, LTD., Komaki-shi (JP)

(21) Appl. No.: 14/202,197

(22) Filed: Mar. 10, 2014

Related U.S. Application Data
(63) Continuation of application No. PCT/JP2012/074798, filed on Sep. 26, 2012.

(30) Foreign Application Priority Data
Jan. 30, 2012 (JP) 2012-016284

(51) Int. Cl. C08K 3/04; C08J 3/20

(52) U.S. Cl. CPC C08K 3/04; C08J 3/20
USPC 524/590

(57) ABSTRACT

A highly durable vibration-damping material is provided. The inventive vibration-damping material comprises a thermoplastic polyurethane elastomer as a major component, and carbon black, wherein the carbon black is dispersed essentially only in a soft segment of the thermoplastic polyurethane elastomer.

### RELATED APPLICATION

This application is a continuation of International Application No. PCT/JP2012/74798, filed on Sep. 26, 2012, which claims priority to Japanese Patent Application No. 2012-016284, filed on Jan. 30, 2012, the entire contents of each of which are hereby incorporated by reference.

### BACKGROUND OF THE INVENTION

1. Field of the Invention

The present invention relates to a vibration-damping material to be used for a vibration-damping rubber bushing (such as a stabilizer bushing or a suspension bushing) for an automotive vehicle such as an automobile, and to a production method therefor.

2. Description of the Related Art

Vibration-damping rubber bushings such as stabilizer bushings and suspension bushings are conventionally employed for automotive vehicles such as automobiles. Natural rubber materials have been used for vibration-damping materials for the vibration-damping rubber bushings. In recent years, it has been proposed to use thermoplastic materials such as thermoplastic elastomers instead of natural rubber materials for cost reduction of the vibration-damping materials (see, for example, JP-A-HEI11 (1999)-257424 and JP-A-2000-109713).

However, thermoplastic materials such as thermoplastic elastomers have a nature intermediate between a rubber and a resin. Therefore, a vibration-damping material prepared from such a thermoplastic material is poorer in durability than the conventional vibration-damping materials prepared from natural rubber materials.

### SUMMARY OF THE INVENTION

In view of the foregoing, a highly durable vibration-damping material and a production method therefor is provided.

The inventors of the present invention conducted intensive studies to provide a highly durable vibration-damping material. The inventors focused on a thermoplastic polyurethane elastomer (TPU) among the thermoplastic elastomers, because the thermoplastic polyurethane elastomer has characteristic properties (tensile characteristics, static characteristics and dynamic characteristics) similar to those of the natural rubbers. After continuing studies, the inventors found that, where carbon black is present in a hard segment of the thermoplastic polyurethane elastomer, isocyanate bond chains in the hard segment cling to particles of the carbon black to reduce the crystallinity of the thermoplastic polyurethane elastomer to thereby reduce the durability of the vibration-damping material. As a result of various experiments, the inventors found that, where the thermoplastic polyurethane elastomer and the carbon black are kneaded at a temperature (20° C. to 100° C.) lower than a conventional kneading temperature (150° C. to 205° C.), the carbon black is dispersed essentially only in a soft segment of the thermoplastic polyurethane elastomer. Further, the inventors found that soft segment polymer chains cling to particles of the carbon black to form so-called pseudo-crosslinking sites whereby the soft segment polymer chains are pseudo-crosslinked to improve the durability of the vibration-damping material, and attained the present invention.

According to a first aspect of the present invention, there is provided a vibration-damping material comprising a thermoplastic polyurethane elastomer as a major component, and carbon black, wherein the carbon black is dispersed essentially only in a soft segment of the thermoplastic polyurethane elastomer.

According to a second aspect of the present invention, there is provided a production method for the vibration-damping material, the method comprising the step of kneading a thermoplastic polyurethane elastomer and carbon black at a temperature of 20° C. to 100° C.

As described above, the inventive vibration-damping material comprises the thermoplastic polyurethane elastomer as the major component and the carbon black, and the carbon black is dispersed essentially only in the soft segment of the thermoplastic polyurethane elastomer. Therefore, the soft segment polymer chains cling to particles of the carbon black to form so-called pseudo-crosslinking sites whereby the soft segment polymer chains are pseudo-crosslinked to improve the durability of the vibration-damping material.

Where the carbon black is present in a proportion of 5 to 50 parts by weight based on 100 parts by weight of the thermoplastic polyurethane elastomer, the durability is further improved.

Where the thermoplastic polyurethane elastomer and the carbon black are kneaded at a higher temperature (150° C. to 205° C.), the TPU is completely melted to permit the carbon black to enter the hard segment, whereby the crystallinity of the TPU is reduced to reduce the durability. In the inventive production method, in contrast, the thermoplastic polyurethane elastomer and the carbon black are kneaded at a lower temperature (20° C. to 100° C.). Therefore, the TPU is not completely melted but half-melted (into a semisolid state which is generally observed just before being completely melted). The carbon black is disaggregated due to the viscous half-melted state of the TPU. Therefore, the carbon black is homogeneously dispersed only in the soft segment, thereby improving the durability.

### DETAILED DESCRIPTION OF THE INVENTION

Next, an embodiment of the present invention will hereinafter be described in detail. However, it should be understood that the invention is not limited to this embodiment.

A vibration-damping material according to the present invention comprises a thermoplastic polyurethane elastomer as a major component and carbon black. A major feature of the present invention is that the carbon black is dispersed essentially only in a soft segment of the thermoplastic polyurethane elastomer.

In the present invention, the expression “the carbon black is dispersed essentially only in a soft segment of the thermoplastic polyurethane elastomer” means that the carbon black is essentially not present or not present at all in a hard segment of the thermoplastic polyurethane elastomer. The expression “the carbon black is essentially not present” means that ultratrace amount of carbon black may be included in the hard segment so that the property thereof cannot be exhibited.

The state of the dispersion of the carbon black in the thermoplastic polyurethane elastomer can be observed, for example, by means of a microscope such as a transmission electron microscope (TEM) or a scanning electron microscope (SEM).

Ingredients of the inventive vibration-damping material will first be described.

### <<Thermoplastic Polyurethane Elastomer>>

The inventive vibration-damping material comprises the thermoplastic polyurethane elastomer as the major component.

In the present invention, the term “major component” means a component that has a significant influence on the characteristic properties of the vibration-damping material. The component is usually present in a proportion of not less than 50 wt % based on an overall weight of the vibration-damping material.

The thermoplastic polyurethane elastomer (TPU) is a polymer which includes a hard phase (hard segment or bound phase) and a soft rubbery phase (soft segment), and is rubbery at an ordinary temperature and thermoplastic at a higher temperature. The thermoplastic polyurethane elastomer is prepared by employing a polyisocyanate and a polyol.

Examples of the polyisocyanate include diisocyanates such as 4,4-diphenylmethane diisocyanate (MDI), 2,4-tolylene diisocyanate (2-TDI), 2,6-tolylene diisocyanate (2,6-TDI), 3,3′-bitolylene-4,4′-deisocyanate, 3,3′-dimethyldiphenylmethane-4,4′-diisocyanate, 2,4-tolylene diisocyanate uretidinedione (dimer of 2,4-TDI), 1,5-naphthylene diisocyanate, m-phenylene diisocyanate, hexamethylene diisocyanate, isophorone diisocyanate, 4,4′-dicyclohexylmethane diisocyanate (hydrogenated MDI), carbodiimide-modified MDI, o-toluidine diisocyanate, xylene diisocyanate, p-phenylene diisocyanate and methyl lysine diisocyanate; triisocyanates such as tripheylmethane-4,4′,4″-triisocyanate; and polymeric MDIs. These polyisocyanates may be used either alone or in combination. Among these polyisocyanates, MDI is particularly preferred in terms of versatility.

Examples of the polyol to be used in combination with the polyisocyanate include a polyester polyol and a polyether polyol, which may be used either alone or in combination.

### <Polyester Polyol>

Usable examples of the polyester polyol include polyether ester polyols and polycarbonate polyester polyols which are prepared through a condensation reaction of a polyvalent alcohol and a polyvalent carboxylic acid in the presence of a solid acid catalyst to thereby have ester bonds.

The polyvalent alcohol is preferably a linear glycol having 2 to 15 main chain carbons, and specific examples thereof include glycols such as ethylene glycol, 1,3-propylene glycol, diethylene glycol, 1,4-butylene glycol, 1,5-pentamethyl glycol, 1,6-hexamethylene glycol, bishydroxyethoxybenzene and p-xylene glycol, which have a hydrocarbon main chain. The polyvalent alcohol preferably has a total carbon number of 3 to 34, more preferably 3 to 17, and specific examples thereof include 2-propylene glycol, 2-methyl-1,3-propanediol, di-1,2-propylene glycol, 1,2-butylene glycol, 1,3-butylene glycol, 2,3-butylene glycol, 2,2-dimethyl-1,3-propanediol, 3-methyl-1,5-pentanediol, 3-methyl-1,3,5-pentanetriol, 2,2,4-trimethyl-1,3-pentanediol, 2-ethyl-1,3-hexanediol, 2,2-dimethyl-3-hydroxypropyl-2,2-dimethyl-3-hydroxypropanate, neopentyl glycol, 2-n-butyl-2-ethyl-1,3-propanediol, 3-ethyl-1,5-pentanediol, 3-propyl-1,5-pentanediol, 2,2-diethyl-1,3-propanediol, 3-octyl-1,5-pentanediol, 2-ethyl-1,3-hexanediol, 3-myristyl-1,5-pentanediol, 3-stearyl-1,5-pentanediol, 3-phenyl-1,5-pentanediol, 3-(4-nonylphenyl)-1,5-pentanediol, 3,3-bis(4-nonylphenyl)-1,5-pentanediol, 1,2-bis(hydroxymethyl)cyclopropane, 1,3-bis(hydroxyethyl)cyclobutane, 1,3-bis(hydroxymethyl)cyclopentane, 1,4-bis(hydroxymethyl)cyclohexane, 1,4-bis(hydroxyethyl)cyclohexane, 1,4-bis(hydroxypropyl)cyclohexane, 1,4-bis(hydroxyethyl)cycloheptane, 1,4-bis(hydroxymethoxy)cyclohexane, 1,4-bis(hydroxyethoxy)cyclohexane, 2,2-bis(4′-hydroxymethoxycyclohexyl)propane, 2,2-bis(4′-hydroxyethoxycyclohexyl)propane and trimethylolpropane, which may be used either alone or in combination.

Any of the aforementioned polyvalent alcohols may be used in combination with a compound having three or more hydroxyl groups. Examples of the compound to be used in combination include polyfunctional polyhydroxy compounds such as glycerin, hexanetriol, triethanolamine, pentaerythritol and ethylenediamine, which are generally used for the polyester polyol.

Examples of the polyvalent carboxylic acid include succinic acid, maleic acid, adipic acid, glutaric acid, pimelic acid, suberic acid, azelaic acid, sebacic acid, 1,9-nonamethylenedicarboxylic acid, 1,10-decamethylenedicarboxylic acid, 1,11-undecamethylenedicarboxylic acid, 1,12-dodecamethylenedicarboxylic acid, dodecanedicarboxylic acid, and aromatic dicarboxylic acids (e.g., phthalic acid, isophthalic acid, terephthalic acid, hexahydroterephthalic acid and hexahydroisophthalic acid, and anhydrides of these acids), which may be used either alone or in combination. From the industrial viewpoint, adipic acid is mainly used. Dimer acids and the like which are prepared through polymerization of a tall oil fatty acid are also usable. Examples of the tall oil fatty acid include mixtures obtained by mixing an unsaturated acid such as oleic acid or linoleic acid with palmitic acid and/or stearic acid.

### <Polyether Polyol>

The polyether polyol has two or more active hydrogen atoms, preferably 2 to 6 active hydrogen atoms, and preferred examples thereof include polyols prepared by adding one or more alkylene oxides (e.g., ethylene oxide, propylene oxide and/or butylene oxide) to any of the aforementioned polyvalent alcohols, glycerin, trimethylolpropane, pentaerythritol, sorbitol, mannitol, ditrimethylolpropane and dipentaerythritol.

### <<Carbon Black>>

Examples of the carbon black include carbon blacks of SAF grade, ISAF grade, HAF grade, MAF grade, FEF grade, GPF grade, SRF grade, FT grade and MT grade, which may be used either alone or in combination.

The carbon black preferably has an average particle diameter of 18 to 122 nm, particularly preferably 20 to 40 nm.

The present invention has a feature such that the carbon black is disaggregated during kneading and homogeneously dispersed with a smaller dispersion particle diameter in the TPU soft segment. The dispersion particle diameter (maximum particle diameter) of the carbon black dispersed in the TPU soft segment is preferably at least 70 μm, particularly preferably at least 50 μm.

The proportion of the carbon black is preferably 5 to 50 parts by weight, particularly preferably 10 to 40 parts by weight, based on 100 parts by weight of the thermoplastic polyurethane elastomer. If the proportion of the carbon black is excessively high, the resulting material tends to have a lower vibration absorbing capability with its excessively high hardness. If the proportion of the carbon black is excessively low, the resulting material tends to have poorer durability.

As appropriate, a foaming agent, a surface active agent, a flame retarder, a colorant, a filler, a plasticizer, a stabilizer, a release agent and an anti-oxidation agent may be blended with the polyisocyanate, the polyol and the carbon black as ingredients for the inventive vibration-damping material.

The inventive vibration-damping material can be produced by kneading the thermoplastic polyurethane elastomer (TPU) and the carbon black at a lower temperature in the order of 20° C. to 100° C. (at a temperature close to a lower limit of a TPU plasticizing temperature) for 3 to 15 minutes, preferably at a temperature of 30° C. to 80° C. for 5 to 10 minutes, and then forming the resulting material into a desired shape by an extrusion method or an injection molding method. If the temperature for the kneading (kneading temperature) is excessively high, the TPU is completely melted, so that the carbon black enters the hard segment of the TPU to reduce the crystallinity of the TPU. Therefore, the resulting vibration-damping material tends to have poorer durability. If the kneading temperature is excessively low, the kneading will be impossible.

In the present invention, in the case of kneading with a twin screw kneading machine, the term “the temperature for the kneading (kneading temperature)” means the temperature of a cylinder of a twin screw kneading machine, but does not mean the temperature of a die of the twin screw kneading machine. The die temperature is usually 150° C. to 200° C. in consideration of the extrudability.

The inventive vibration-damping material preferably has a hardness (JIS A hardness) of 50 to 85, particularly preferably 60 to 70.

### EXAMPLES

The present invention will hereinafter be described more specifically by way of examples. It should be understood that the present invention is not limited to these examples and may be implemented in various other embodiments without departing from the scope of the invention. In the examples, “part” is based on weight, unless otherwise specified.

The following ingredients were prepared for the inventive examples and the comparative examples.

### <Ester-Based TPU>

KURAMIRON 8165 available from Kuraray Co., Ltd.

### <Ether-Based TPU>

KURAMIRON 9185 available from Kuraray Co., Ltd.
<Carbon Black (i)>
SEAST SO available from Tokai Carbon Co., Ltd.
<Carbon Black (ii)>
SHOWBLACK N330 available from Showa Cabot K. K.
<Carbon Black (iii)>
SEAST V available from Tokai Carbon Co., Ltd.

### Example 1

A vibration-damping rubber composition was prepared by kneading 100 parts of the ester-based TPU (KURAMIRON 8165 available from Kuraray Co., Ltd.) and 5 parts of the carbon black (i) (SEAST SO available from Tokai Carbon Co., Ltd.) at a kneading temperature (settable cylinder temperature) of 30° C. for 10 minutes by means of a twin screw kneading machine (Tex30α available from JSW) (with a die temperature set at 200° C. in consideration of the extrudability).

### Examples 2 to 8 and Comparative Examples 1 to 6

Vibration-damping rubber compositions were prepared in substantially the same manner as in Example 1, except that the types and the proportions of the ingredients and the kneading conditions (kneading temperature and kneading period) were changed as shown below in Tables 1 and 2.

TABLE 1
(parts by weight)

| | Example | | | | | | | |
|---|---|---|---|---|---|---|---|---|
| | 1 | 2 | 3 | 4 | 5 | 6 | 7 | 8 |
| Ester-based TPU | 100 | 100 | 100 | 100 | 100 | — | 100 | 100 |
| Ether-based TPU | — | — | — | — | — | 100 | — | — |
| Carbon black (i) | 5 | 15 | 25 | 40 | 50 | 25 | — | — |
| Carbon black (ii) | — | — | — | — | — | — | 10 | — |
| Carbon | — | — | — | — | — | — | — | 10 |
| black (iii) | | | | | | | | |
| Kneading temperature | Low | Low | Low | Low | Low | Low | Low | Low |
| ° C. | 30 | 30 | 30 | 30 | 30 | 30 | 30 | 30 |
| Kneading period (min) | 10 | 5 | 3 | 15 | 3 | 3 | 3 | 3 |
| Tensile breaking | 26 | 27 | 32 | 33 | 35 | 31 | 29 | 20 |
| strength (MPa) | | | | | | | | |
| Tensile breaking | 810 | 780 | 700 | 540 | 450 | 720 | 770 | 840 |
| elongation (%) | | | | | | | | |
| Durability | Δ | ∘ | ∘ | ∘ | ∘ | ∘ | ∘ | ∘ |
| Dispersion of carbon | ∘ | ∘ | ∘ | ∘ | ∘ | ∘ | ∘ | ∘ |
| black (evaluation) | | | | | | | | |
| Dispersion particle | ∘ | ∘ | ∘ | ∘ | ∘ | ∘ | ∘ | ∘ |
| diameter of carbon | | | | | | | | |
| black (evaluation) | | | | | | | | |

TABLE 2
(parts by weight)

| | Comparative Example | | | | | |
|---|---|---|---|---|---|---|
| | 1 | 2 | 3 | 4 | 5 | 6 |
| Ester-based TPU | 100 | — | 100 | 100 | — | 100 |
| Ether-based TPU | — | 100 | — | — | 100 | — |
| Carbon black (i) | — | — | 60 | 15 | 15 | 25 |
| Kneading temperature | Low | Low | Low | High | High | High |
| ° C. | 30 | 30 | 30 | 150 | 150 | 120 |
| Kneading period (min) | 3 | 3 | 3 | 3 | 3 | 3 |
| Tensile breaking | 25 | 32 | 9 | 14 | 15 | 13 |
| strength (MPa) | | | | | | |
| Tensile breaking | 900 | 650 | 140 | 760 | 570 | 660 |
| elongation (%) | | | | | | |
| Durability | x | x | x | x | x | x |
| Dispersion of carbon | — | — | x | x | x | x |
| black (evaluation) | | | | | | |
| Dispersion particle | — | — | x | x | x | x |
| diameter of carbon | | | | | | |
| black (evaluation) | | | | | | |

The products of the inventive examples and the comparative examples were evaluated for characteristic properties based on the following criteria. The results are also shown above in Tables 1 and 2.

### <Tensile Breaking Strength and Tensile Breaking Elongation>

The tensile breaking strength and the tensile breaking elongation of each of the vibration-damping rubber compositions were measured in conformity with JIS K6251.

### <Durability>

Two iron plates (having a thickness of 6 mm and a size of 45 mm×45 mm) were prepared, and the vibration-damping rubber compositions were each injection-molded between the two iron plates. Thus, a test strip (having a thickness of 32 mm and a size of 36 mm×40 mm) was prepared. It is noted that an adhesive agent (CHEMLOK C210 available from Lord Far East Incorporated) was applied to portions of the iron plates to be brought into contact with the vibration-damping rubber composition. The resulting test strip was evaluated for durability (with a load of 0±4000 N at an ordinary ambient temperature at a rate of 3 Hz). A test strip that was cracked when being vibrated less than 20,000 times was rated as unacceptable (x), and a test strip that was cracked when being vibrated not less than 20,000 times and less than 100,000 times was rated as acceptable (Δ). A test strip that was cracked when being vibrated not less than 100,000 times was rated as excellent (∘).

### <Dispersion of Carbon Black and Dispersion Particle Diameter of Carbon Black>

The vibration-damping rubber compositions were each injection-molded into a sheet (having a thickness of 2 mm). Then, the sheet was cut by means of LEIKA RM 2155, and its section was observed by means of an SPM of MMAFM-8 Model available from Buruker Corporation for checking the dispersion state of the carbon black in the thermoplastic polyurethane elastomer (TPU). In evaluation, a sheet in which the carbon black was dispersed only in a soft segment was rated as acceptable (∘), and a sheet in which the carbon black was dispersed in a hard segment as well as a soft segment was rated as unacceptable (x).

Further, the dispersion particle diameter of the carbon black dispersed in the TPU was measured. For the measurement, the sheet was observed at a magnification of ×175 by means of VHX-1000 available from KEYENCE Corporation. Then, 100 observable carbon black particles were arbitrarily chosen, and the dispersion particle diameters of the carbon black particles were measured. In evaluation, a sheet in which the carbon black was dispersed with a maximum dispersion particle diameter of not greater than 70 μm was rated as acceptable (∘), and a sheet in which the carbon black was dispersed with a maximum dispersion particle diameter of greater than 70 μm was rated as unacceptable (x).

The results of the evaluation indicate that the products of the inventive examples were excellent in tensile breaking strength, tensile breaking elongation and durability, because the carbon black was present only in the soft segment of the TPU but not dispersed in the hard segment of the TPU.

On the other hand, the products of Comparative Examples 1 and 2 were poorer in durability, because no carbon black was blended.

The product of Comparative Example 3 was poorer in tensile breaking strength, tensile breaking elongation and durability, because the carbon black was blended in a greater proportion and dispersed in the hard segment of the TPU as well.

The products of Comparative Examples 4 to 6 each prepared by kneading the TPU and the carbon black at a higher temperature were poorer in durability, because the TPU was completely melted and the carbon black was dispersed in the hard segment of the TPU as well.

While specific forms of the embodiment of the present invention have been shown in the aforementioned inventive examples, the inventive examples are merely illustrative of the invention but not limitative of the invention. It is contemplated that various modifications apparent to those skilled in the art could be made within the scope of the invention.

The inventive vibration-damping material can be advantageously used, for example, for a vibration-damping bushing (a stabilizer bushing, a suspension bushing or the like) for an automotive vehicle such as an automobile not by way of limitation. The inventive vibration-damping material may be used for a joint member of a robot or the like.

1. A vibration-damping material comprising:
a thermoplastic polyurethane elastomer as a major component; and
carbon black;
wherein the carbon black is dispersed essentially only in a soft segment of the thermoplastic polyurethane elastomer.

2. The vibration-damping material according to claim 1, wherein the carbon black is present in a proportion of 5 to 50 parts by weight based on 100 parts by weight of the thermoplastic polyurethane elastomer.

3. A production method for the vibration-damping material according to claim 1, the method comprising the step of kneading a thermoplastic polyurethane elastomer and carbon black at a temperature of 20° C. to 100° C.

4. A production method for the vibration-damping material according to claim 2, the method comprising the step of kneading a thermoplastic polyurethane elastomer and carbon black at a temperature of 20° C. to 100°.
